(19) United States
(12) Patent Application Publication
(10) Pub. No.: US 2017/0083677 A1
(43) Pub. Date: Mar. 23, 2017

(54) SYSTEM AND A METHOD FOR REMOTE HEALTH TESTING AND DIAGNOSTICS

(71) Applicants: Laszlo Osvath, Dundas (CA); Colin Shapiro, Toronto (CA)

(72) Inventors: Laszlo Osvath, Dundas (CA); Colin Shapiro, Toronto (CA)

(21) Appl. No.: 15/253,032

(22) Filed: Aug. 31, 2016

Related U.S. Application Data
(60) Provisional application No. 62/212,843, filed on Sep. 1, 2015.

(51) Int. Cl. G06F 19/00

(52) U.S. Cl. CPC G06F 19/3418; G06F 19/324; G06F 19/328

(57) ABSTRACT

According to some aspects, one or more systems and methods for remote testing and diagnostics of at least one patient. In some embodiments, the system comprises at least one personal recorder, configured to record at least one set of test data during at least one self-applied test; at least one data collection point; and a data center configured to analyze the at least one set of the test data received from the at least one data collection point, and generate at least one report.

### RELATED APPLICATIONS

This application claims the benefit of U.S. Provisional Patent Application Ser. No. 62/212,843 filed Sep. 1, 2016 and entitled A SYSTEM AND A METHOD FOR REMOTE HEALTH TESTING AND DIAGNOSTICS, the entire contents of which are hereby incorporated by reference herein for all purposes.

### FIELD

Various embodiments are described herein that generally relate to systems and methods for remote testing and diagnostics of patients.

### INTRODUCTION

Currently, a large number of health conditions, disorders and diseases remain undiagnosed and untreated. For example, sleep apnea remains undiagnosed in 85%-90% of the population, leading to significant health consequences. Most people live their lives without ever seeing a sleep specialist because the primary care facilities are neither equipped, nor capable of identifying sleep problems.

Modern diagnostic techniques rely on expensive equipment, expensive real estate, and trained technologists. Moreover, one laboratory can test only a very limited number of patients a day. Screening a large number of patients, such as an army, a workforce, or a population of a country, becomes impossible with the current approach.

Costly tests and low testing capacity of laboratories considerably restrict diagnostics related to various sleep and mental health disorders, as well as other health problems, such as, for example, respiratory and cardiovascular diseases.

### SUMMARY

In a first aspect, in at least one example embodiment described herein, a system is provided for remote testing and diagnostics of at least one patient. In at least one embodiment, the system may include at least one personal recorder, configured to record at least one set of test data during at least one self-applied test; at least one data collection point configured to receive the at least one set of the test data from the at least one personal recorder and to receive patient identification data; and a data center. The data center may be configured to analyze the at least one set of the test data received from the at least one data collection point, and generate at least one first report based on the analysis of the at least one set of the test data.

In at least one embodiment, the data collection point may be further configured to provide the at least one personal recorder to the at least one patient.

In at least one embodiment, the personal recorder may be configured to test the patient for at least one sleep disorder. In at least one embodiment, the personal recorder may be configured to test the patient for depression. In at least one embodiment, the personal recorder may be configured to test respiratory system of the patient. In at least one embodiment, the personal recorder may be configured to test for at least one cardiovascular disorder. In at least one embodiment, the personal recorder may be configured to test for at least one neurological disorder. In at least one embodiment, the personal recorder may be configured to test for pain. In at least one embodiment, the personal recorder may be configured to test for fatigue. In at least one embodiment, the personal recorder may be configured to test for at least one neuromuscular disorder.

In at least one embodiment, the data collection point may further comprise a ground terminal and a ground dispatcher, the ground dispatcher configured to receive the at least one set of test data from the ground terminal and to transmit the at least one set of test data to the data center.

In at least one embodiment, the ground terminal is further configured to: receive at least one set of patient identification data; and transmit the at least one set of the patient identification data to the ground dispatcher.

In at least one embodiment, the ground dispatcher is further configured to generate a second report, the second report comprising the first report and the patient identification data. In at least one embodiment, the ground dispatcher is further configured to send the second report to at least one health practitioner. In at least one embodiment, the ground dispatcher is further configured to send the second report to at least one operator of the data collection point.

In at least one embodiment, the data center may further comprise at least one worker machine configured to analyze the at least one set of test data; and a cloud dispatcher configured to transmit the at least one set of the test data, received from the data collection point, to the at least one worker machine. In at least one embodiment, the data center may be further configured to transmit the at least one first report to the at least one data collection point.

In at least one embodiment, the ground dispatcher may be further configured to collect the at least one set of test data at the ground terminal and to collect the at least one first report at the data center. In at least one embodiment, the ground dispatcher may further comprise a reporter configured to generate the at least one second report.

In at least one embodiment, the data collection point may be further configured to store and to update a health practitioners' list, the health practitioners' list comprising contact information of at least one health practitioner. In at least one embodiment, the data collection point may be further configured to update and store patient identification data.

In at least one embodiment, the analysis of the at least one set of test data may be fully automated.

In at least one embodiment, the system may further comprise electronic billing system.

In at least one embodiment, the first report may indicate whether the second report needs to be sent to a health practitioner.

In another aspect, in at least one example embodiment described herein, there is provided a method for remote (health) testing and diagnostics of at least one patient, the method may comprise collecting at least one set of test data from at least one personal recorder, the personal recorder being configured to record the at least one set of test data during at least one self-applied test; transmitting the at least one set of the test data from a data collection point to a data center; analyzing the at least one set of the test data by the data center; and generating, by the data center, at least one first report based on the analysis of the at least one set of the test data.

In at least one embodiment, the method may further comprise storing and updating a health practitioners' list, the health practitioners' list comprising contact information of at least one health practitioner.

In at least one embodiment, the method may further comprise receiving patient identification data by a data collection point from the patient; receiving a first report by a data collection point from the data center; generating a second report at the data collection point, the second report comprising the first report and the patient identification data; and transmitting the second report to at least one affiliated health practitioner, the affiliated health practitioner being determined based on the patient identification data and the health practitioners' list.

In at least one embodiment, the method may further comprise supplying the at least one personal recorder to the patient.

In at least one embodiment, the method may further comprise billing and charging the at least one patient.

In at least one embodiment, the method may further comprise operating a website.

In at least one embodiment, the method may further comprise providing a monitoring service.

### DRAWINGS

For a better understanding of the various embodiments described herein, and to show more clearly how these various embodiments may be carried into effect, reference will be made, by way of example, to the accompanying drawings which show at least one example embodiment, and in which:

FIG. 1 is a schematic diagram illustrating an example embodiment of a system for remote health testing and diagnostics of patients;

FIG. 2 is a schematic diagram illustrating an example embodiment of a portion of the system for remote testing and diagnostics;

FIG. 3 is a block diagram illustrating an example embodiment of a method for remote (health) testing and diagnostics, in accordance with at least one embodiment;

FIG. 4 is a schematic diagram illustrating an example embodiment of another portion of the system for remote testing and diagnostics;

FIG. 5 is a schematic diagram illustrating an example embodiment of a data collection point.

### DESCRIPTION OF VARIOUS EMBODIMENTS

Various apparatuses or processes will be described below to provide an example of an embodiment of each claimed invention. No embodiment described below limits any claimed invention and any claimed invention may cover processes or apparatuses that differ from those described below. The claimed inventions are not limited to apparatuses or processes having all of the features of any one apparatus or process described below or to features common to multiple or all of the apparatuses or processes described below. It is possible that an apparatus or process described below is not an embodiment of any claimed invention. Any invention disclosed in an apparatus or process described below that is not claimed in this document may be the subject matter of another protective instrument, for example, a continuing patent application, and the applicants, inventors or owners do not intend to abandon, disclaim or dedicate to the public any such invention by its disclosure in this document.

Furthermore, it will be appreciated that for simplicity and clarity of illustration, where considered appropriate, reference numerals may be repeated among the figures to indicate corresponding or analogous elements.

A description of an embodiment with several components in communication with each other does not imply that all such components are required. On the contrary, a variety of optional components are described to illustrate the wide variety of possible embodiments of the present invention.

Further, although process steps, method steps, algorithms or the like may be described (in the disclosure and/or in the claims) in a sequential order, such processes, methods and algorithms may be configured to work in alternate orders. In other words, any sequence or order of steps that may be described does not necessarily indicate a requirement that the steps be performed in that order. The steps of processes described herein may be performed in any order that is practical. Further, some steps may be performed simultaneously.

The various embodiments of the systems and methods described herein may be implemented in hardware or software, or a combination of both. For example, some embodiments may be implemented in computer systems and computer programs, which may be stored on a physical computer readable medium, executable on programmable computers (e.g. computing devices and/or processing devices) each comprising at least one processor, a data storage system (including volatile and non-volatile memory and/or storage elements), at least one input device (e.g. a keyboard, mouse or touchscreen), and at least one output device (e.g. a display screen, a network, or a remote server).

For example, and without limitation, the programmable computers may include servers, personal computers, laptops, tablets, personal data assistants (PDA), cell phones, smart phones, gaming devices, watch, and other mobile devices. Program code can be applied to input data to perform the functions described herein and to generate output information. The output information can then be supplied to one or more output devices for outputting to one or more users.

In some embodiments, each program may be implemented in a high level procedural or object oriented programming and/or scripting language to communicate with a computer system. However, the programs can be implemented in assembly or machine language, if desired. In any case, the language may be a compiled or interpreted language.

In some embodiments, the systems and methods as described herein may also be implemented as a non-transitory computer-readable storage medium configured with a computer program, wherein the storage medium so configured causes a computer to operate in a specific and predefined manner to perform at least some of the functions as described herein.

The terms “an embodiment”, “embodiment”, “embodiments”, “the embodiment”, “the embodiments”, “one or more embodiments”, “some embodiments” and “one embodiment” mean “one or more (but not all) embodiments of the present invention(s)” unless expressly specified otherwise.

The terms “including”, “comprising” and variations thereof mean “including but not limited to”, unless expressly specified otherwise. A listing of items does not imply that any or all of the items are mutually exclusive, unless expressly specified otherwise. The terms “a”, “an” and “the” mean “one or more”, unless expressly specified otherwise.

In addition, as used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

It should be understood that the term “data”, such as, for example, in “test data” or “patient identification data”, may comprise “at least one set of data” and/or “at least one portion of data”. It should also be understood, where term “at least one portion of the data” is used, the same may apply to “data” in general and/or “at least one set of the data”, It should also be understood, where term “at least one set of the data” is used, the same may apply to “data” in general and/or “at least one portion of the data”.

Diagnostics of many health conditions, disorders, and diseases would benefit from having tools that could assist in identifying the patients without bringing them to the lab. In absence of qualified healthcare personnel, the automated screening methods can provide a useful aid in identifying and channeling the patients toward treatment solutions.

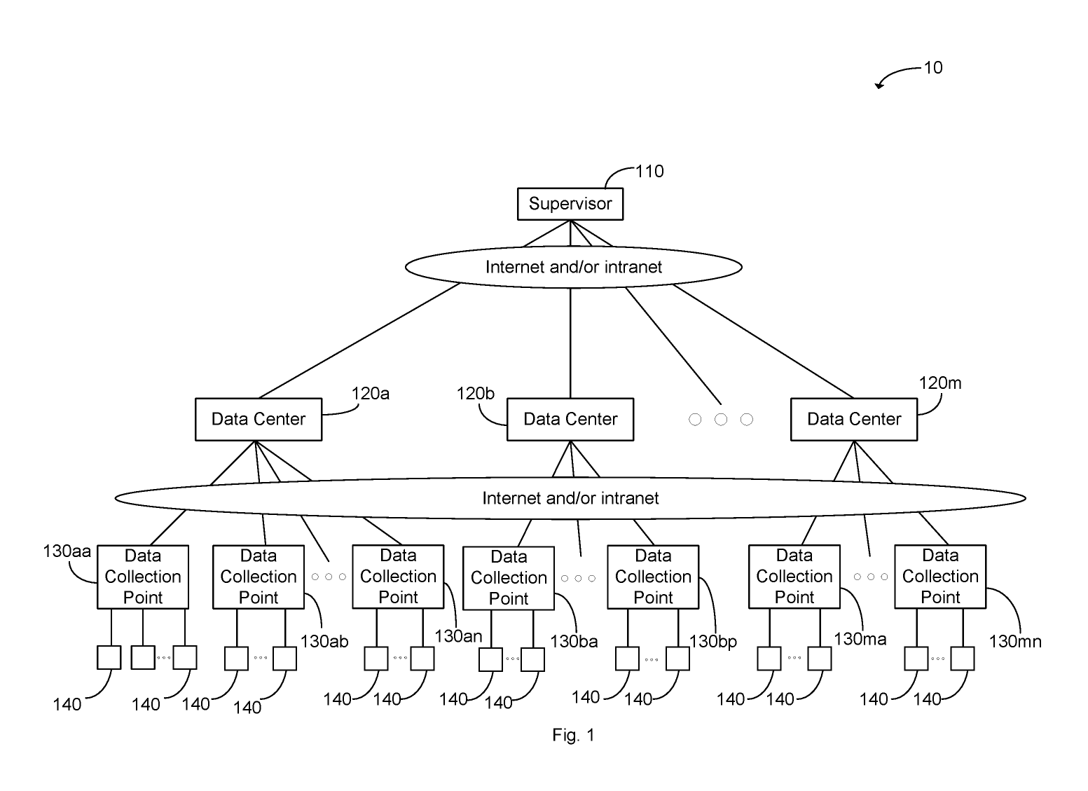

Referring now to FIG. 1, illustrated therein is a system 10 for remote testing and diagnostics of at least one patient, according to some embodiments. The system may comprise a supervisor 110, at least one data center 120, at least one data collection point 130, and at least one personal recorder 140.

According to various exemplary embodiments, a supervisor may be operably connected with one or more data centers 120. For example, as shown at FIG. 1, the supervisor 110 may be operatively connected with m data centers 120a, 120b . . . 120m.

According to various exemplary embodiments, each data center 120 may be operably connected with one or more data collection points 130. For example, as shown in FIG. 1, data center 120a may be operatively connected to n data collection points 130aa, 130ab . . . 130an, while data center 120b may be operatively connected to p data collection points 130ba, 130bb . . . 130bp, etc. According to at least one embodiment, the data centers 120 may have various numbers of affiliated data collection points 130. Each data collection point 130 may have at least one associated data center 120.

According to at least one embodiment, any number of data centers 120 and any number of data collection points 130 may be added to the system 10. This may permit the system 10 to be scalable.

According to at least one embodiment, the data collection point 130 may be an office operated by a clerk, a booth, an installation similar to a vending machine, or any other installation configured to provide the at least one personal recorder 140 to a patient.

For example, the data collection point 130 may be installed at a pharmacy, a mall, a battle ship, or a remote mining site. For example, the data collection point 130 may be installed where health workers, medical practitioners or technologists specializing in a specific health field are not available. For example, the data collection point 130 may be installed many kilometers away from the nearest health practitioner. For example, the data collection point 130 may be installed many kilometers away from the data center 120 it is affiliated to.

According to at least one embodiment, each data collection point 130 may have at the least one personal recorder 140. For example, the personal recorder 140 may be a personal test kit or other personal equipment configured to test patient's health disorders, including mental health disorders.

According to at least one embodiment, the personal recorder 140 may be configured to test the patient for at least one sleep disorder. According to at least one embodiment, the personal recorder 140 may be configured to perform at least one cardiology test. According to at least one embodiment, the personal recorder may be configured to test cardiovascular disorders. According to at least one embodiment, the personal recorder 140 may be configured to perform pre-surgery test.

According to at least one embodiment, the personal recorder 140 may be configured to test the patient for depression. According to at least one embodiment, the personal recorder 140 may be configured to test respiratory system of the patient.

According to at least one embodiment, the personal recorder may be configured to test neurological disorders. The tested neurological disorders may be, for example, epilepsy, dementia, or Parkinson's disease.

According to at least one embodiment, the personal recorder may be configured to test pain. For example, the personal recorder may be configured to test fibromyalgia. According to at least one embodiment, the personal recorder may be configured to test fatigue. According to at least one embodiment, the personal recorder may be configured to test neuromuscular disorders.

According to at least one embodiment, the personal recorder 140 may be portable. The personal recorder 140 may be configured to perform a self-applied test. According to at least one embodiment, the personal recorder 140 may not need a health professional or a technologist to operate the test.

For example, the patient may receive the personal recorder 140 at the data collection point 130. In another example, the personal recorder 140 may be collected by a person other than the patient. For example, this may be possible if there is no need to certify a patient's identity.

According to at least one embodiment, the data collection point 130 or an operator of the data collection point 130 may operate a website. For example, a patient may be able to order at least one test. For example, a patient may purchase or rent the at least one personal recorder 140 at the website. According to at least one embodiment, the at least one personal recorder 140 may be picked up at the data collection point 130 or delivered to the patient's home or to another address.

For example, the self-applied test may be performed at home or at any other location, remote from the data collection point 130. For example, the patient may apply the test at home using the personal recorder 140.

During the test, the personal recorder 140 may record test data. For example, the personal recorder 140 may record the test data and save it on its hard drive. After the test data has been collected by the personal recorder 140, the patient may then bring the personal recorder 140 to one of data collection points 130. For example, the patient may bring the personal recorder 140 to the same data collection point 130 where he received it.

According to at least one embodiment, the collected test data may be uploaded from the personal recorder 140 to the website and/or data collection point 130 at the patient's home using a mobile device or other programmable computer.

According to at least one embodiment, a patient and/or a family and/or a family member may purchase a personal recorder 140. In at least one embodiment, the patient and/or his family may own the personal recorder 140.

According to at least one embodiment, an owner of the personal recorder 140 or a rentee of the personal recorder 140 (a patient or a family who has rented the personal recorder 140) may subscribe to a monitoring service. For example, an owner or the rentee of the personal recorder 140 may subscribe for monitoring with an operator of the data collection point 130.

For example, the patient may have or perform one or more tests. For example, monitoring and the number of tests performed may depend on the patient's condition. For example, an impact and/or an outcome of a treatment may be monitored during or after the treatment.

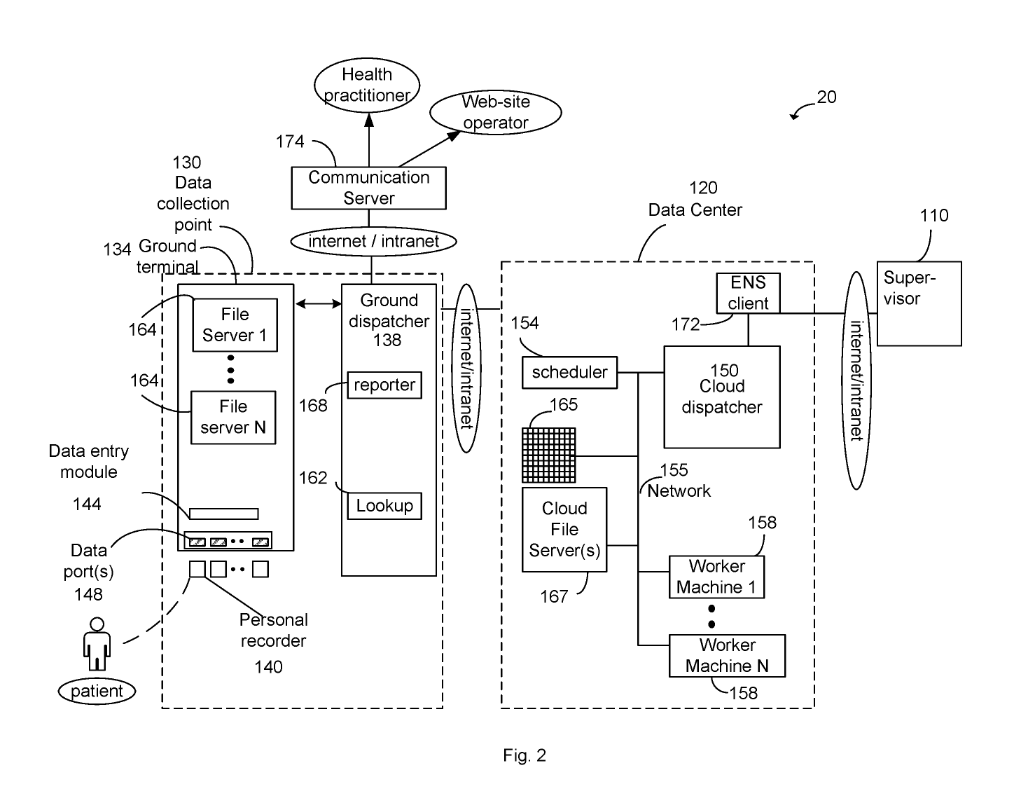

Referring now to FIG. 2, illustrated therein is a portion 20 of the system 10, in accordance with at least one embodiment. The data collection point 130 may comprise at least one ground terminal 134 and at least one ground dispatcher 138, both operatively connected to each other.

According to at least one embodiment, the ground terminal 134 may comprise at least one data entry module 144, at least one data port 148, and at least one file server 164. For example, the data entry module 144 may be a programmable computer or at least a portion of the programmable computer.

According to at least one embodiment, the ground dispatcher 138 may comprise at least one lookup module 162 and at least one reporter 168.

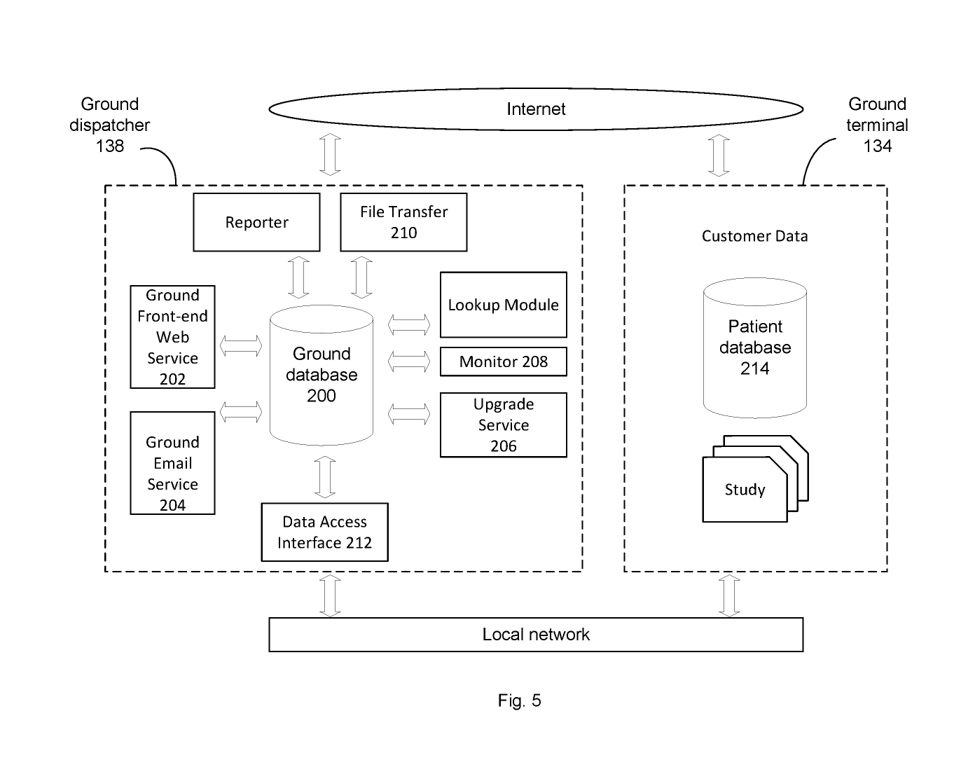

FIG. 5 shows a schematic diagram of the data collection point 130, in accordance with at least one embodiment. According to at least one embodiment, the ground dispatcher 138 may also comprise a ground database 200, a ground front-end web-service 202, a ground e-mail service 204, a ground upgrade service 206, a ground monitor service 208, a ground file transfer module 210 and a ground data access interface 212. The ground terminal 134 may also comprise a patient database 214.

Referring back to FIG. 2, the data center 120 may comprise a cloud dispatcher 150, at least one scheduler 154, at least one worker machine 158, and at least one client 172. According to at least one embodiment, the data center 120 may also comprise one or more file servers 167.

According to at least one embodiment, the data center 120 may further comprise a back-end web service, a data access service and a file transfer service, as well as a data center monitor.

According to at least one embodiment, the data collection point 130 and the data center 120 may be operatively connected via internet or intranet. According to at least one embodiment, the data center 120 may be operatively connected with the supervisor 110 via internet or intranet.

According to at least one embodiment, the cloud dispatcher 150 may comprise the scheduler 154. According to at least one embodiment, the cloud dispatcher 150 may be a separate unit from the scheduler 154, and may be operatively connected to the scheduler 154 via a network 155 of the data center 120.

According to at least one embodiment, the system 20 may be scalable such that any number of additional worker machines 158 and/or file servers 167 may be added to any data center 120.

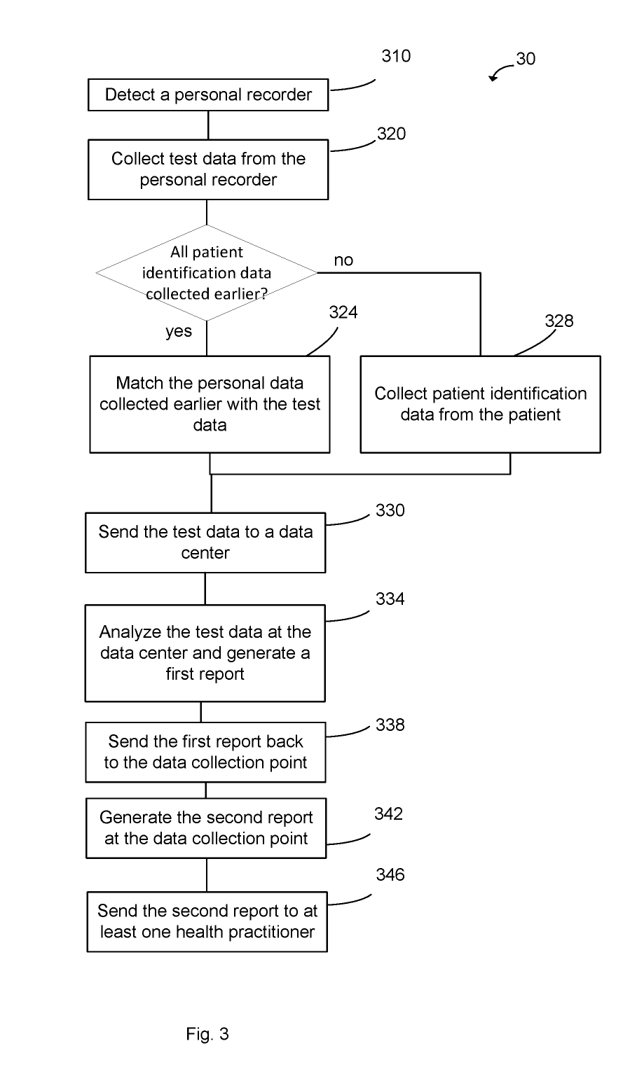

Referring to FIG. 3, shown therein is a method 30 for remote testing and diagnostics of the patients, in accordance with at least one embodiment. According to at least one embodiment, when the personal recorder 140 is returned to the data collection point 130, the data collection point 130 may detect the personal recorder 140 and operatively connect with it at steps 310 and 320 of the method 30. For example, the personal recorder 140 may connect automatically to the data collection point 130 using at least one of wireless technologies. For example, prior to connecting to the personal recorder 140, the data collection point 130 may ask the operator for permission to do so. For example, prior to connecting with the data collection point 130, the personal recorder 140 may ask for permission. In another example, the personal recorder may be plugged into the ground terminal 134 using at least one data port 148. According to at least one embodiment, when the personal recorder 140 is operatively connected to the data collection point 130, the data from the personal recorder 140, including the test data, may be uploaded to the ground terminal 134 at step 320.

According to at least one embodiment, after the test data has been uploaded to the ground terminal 134, the personal recorder 140 may be prepared for the next use by the same or another patient. For example, the personal recorder 140 may be cleaned and/or re-formatted. For example, the personal recorder 140 may be sterilized and/or repackaged. For example, disposable accessories of the personal recorder 140 may be replaced. For example, at least one electrode and/or at least one cannula may be replaced.

According to at least one embodiment, the data entry module 144 may collect the patient identification data. For example, the patient identification data may include a patient's full name, gender, age, phone number, email, and/or other patient's identification information. For example, the patient identification data may include also patient's address, a name of the health practitioner of the patient, and/or any other data related to the patient.

The patient identification data may be collected, for example, at the same time when the test data is collected from the personal recorder 140. In another example, the patient identification data may be collected before or after the test data is collected from the personal recorder 140. In yet another example, the patient identification data may be collected when the patient first receives the personal recorder 140. In this example, when the personal recorder 140 is returned to the data collection point 130, the patient information data may be matched with the test data uploaded from the personal recorder 140.

For example, the patient identification data may be collected from the patient by a clerk. In another example embodiment, the patient may enter the patient identification data using the data entry module 144. In another example embodiment, the patient identification data may be collected by pairing of the data entry module 144 with the patient's smart phone, or any other computing device or a programmable computer. The information may be entered by the patient on his/her computing device or programmable computer, and/or collected automatically from the computing device or the programmable computer. For example, the patient identification data may be collected from the patient by the personal recorder 140 and then uploaded to the data collection point 130.

If all required patient identification information has been collected earlier, for example, when the personal recorder 140 has been released to the patient, then the patient identification data may be matched with the test data at step 324. According to at least one embodiment, although the test data and patient identification data may be matched at step 324, the test data alone may not contain any patient's identification data. This may help to ensure the patient's confidentiality when the test data is sent later to the data center 120 at step 330. According to at least one embodiment, the patient identification data may be kept at the data collection point 130 and may not be transmitted to the data center 120.

For example, the data collection point 130 may be operated by at least one operator or an organization. According to at least one embodiment, the patient identification data may be obtained from the patient and recorded at the data collection point 130 by the operator of the data collection point 130.

After the test data has been uploaded to the ground terminal 134, the ground terminal 134 may then transmit the test data and the patient identification data to the ground dispatcher 138. According to at least one embodiment, the ground terminal 134 may not know about the existence of the ground dispatcher 138.

According to at least one embodiment, the lookup module 162 of the ground dispatcher 138 may scan the ground terminal 134 searching for the at least one set of test data. For example, the lookup module 162 may search for new set or sets of test data. According to at least one embodiment, the ground dispatcher 138, or a lookup module 162 of the ground dispatcher 138, may collect the at least one set of test data at the ground terminal 134. According to at least one embodiment, the lookup module 162 may transmit the received test data to at least one file server 164.

According to at least one embodiment, the lookup module 162 may scan the ground terminal 134 to find at least one file server 164. According to at least one embodiment, the lookup module 162 may verify whether each file server 164 containing at least one set of the test data (data source) is active. For example, the data source may be active if it is accessible. According to at least one embodiment, the lookup module 162 may discard or ignore inactive data sources.

The ground dispatcher 138 may receive at least one set of test data from the ground terminal 134. For example, the ground dispatcher 138 may record patient identification data. The ground dispatcher 138 may also record the test data.

According to at least one embodiment, the ground dispatcher 138 may then transmit the test data, or at least one portion of the test data, or at least one set of the test data to the data center 120 at step 330 of the method 30. According to at least one embodiment, the ground dispatcher 138 of the data collection point 130 may send the test data to the cloud dispatcher 150 of the data center 120.

According to at least one embodiment, the cloud dispatcher 150 may transmit the received test data or the at least one set of the received test data or at least one portion of the test data to at least one cloud file server 167. For example, the at least one cloud file server 167 may receive, collect, and/or store files with at least one set of the test data.

According to at least one embodiment, a database 165 may be stored in the cloud dispatcher 159 or the scheduler 154.

According to at least one embodiment, the database 165 may comprise at least one record for each cloud file server 167 which may store at least one set of test data.

According to at least one embodiment, the database 165 may comprise at least one set of the test data.

According to at least one embodiment, the database 165 may comprise at least one task record. For example, one task record may comprise information related to analysis of one set of test data. For example, the database 165 may comprise at least one list of scheduled tasks and at least one list of performed tasks. For example, each task record may comprise information regarding whether the task has been performed and/or whether the task has been scheduled.

According to at least one embodiment, for each set of data and/or task, the database 165 may comprise a data collection point record, which may specify the data collection point 130, from which the corresponding set of test data has originated.

According to at least one embodiment, for each task record, the database 165 may comprise a credit record. For example, one credit may correspond to one prepaid test available to the data collection point 130, from which the set of test data has originated.

According to at least one embodiment, the scheduler 154 and/or the worker machine 158 may request and/or acquire and/or obtain at least one credit from the supervisor 110 for each task. The scheduler 154 and/or worker machine 158 may save and/or update the credit record in the database 165.

According to at least one embodiment, the database 165 may comprise at least one test report. For example, the database 165 may comprise, for each task record, at least one preliminary test report, at least one test analysis report. For example, the preliminary test report may be generated when the data center 120 has first received a particular set of the test data. For example, the preliminary report may comprise data in binary form. For example, the analysis report may be generated after the analysis of the particular set of data has been performed. For example, the analysis report may comprise data in binary form. For example, the diagnostics report may be generated just before being sent to the data collection point 130.

Referring back to FIGS. 2 and 3, according to at least one embodiment, the network 155 may be operatively connected to the at least one cloud file server 167 comprising at least one test data.

According to at least one embodiment, the scheduler 154 may access the database 165 in order to analyze records and to identify and/or enumerate each test data found on the corresponding cloud file server 167. For example, the scheduler 154 may create or update the at least one task record for each test data found on the corresponding cloud file server 167.

According to at least one embodiment, the cloud dispatcher 150 may task the scheduler 154 to generate at least one task for at least one worker machine 158. For example, the scheduler 154 may determine how to distribute the tasks evenly between the worker machines 158. For example, the scheduler 154 may determine in which sequence the tasks have to be performed and/or record the task's priority in the database 165.

According to at least one embodiment, the scheduler 154 may keep track of how many worker machines 158 are busy and with how many tasks, as well as how many worker machines 158 are not busy with any task.

According to at least one embodiment, the scheduler may send at least one task to at least one worker machine 158. According to at least one embodiment, the scheduler 154 may assign the task priority to establish a task queue in the database 165. According to at least one embodiment, the worker machines 158 may consult the database 165 to pull a next assigned task.

For example, the scheduler 154 may first assign and /or send one task to each worker machine 158. When all the worker machines 158 are busy with at least one task, the scheduler 154 may then send a second task to each worker machine 158, and so on for further tasks. For example, the scheduler 154 may determine a maximum of tasks to be performed at the same time by one worker machine 158. In this case, when all worker machines 158 of the data center 120 are busy, the scheduler 154 may generate and schedule a task for the next available machine 158. For example, the worker machine 158 may become available when the number of tasks it performs at a certain moment becomes less than a threshold or a maximum number of tasks to be performed by one worker machine 158.

For example, the worker machine 158 may use the at least one task record, as scheduled by the scheduler 154 earlier, to begin data processing.

According to at least one embodiment, if the at least one credit has been acquired successfully, and/or the credit record exists in the database 165, the worker machine 158 may access the corresponding set of the test data and perform data processing.

According to at least one embodiment, the worker machine 158 may report the result of data processing back to the cloud dispatcher 150. According to at least one embodiment, the worker machine 158 may send the result of data processing to the database 165 and/or record it in the database 165. For example, the result of the data processing may be associated with the task record in the database 165.

According to at least one embodiment, the scheduler 154 may analyze and evaluate at least one data folder, containing the test data. According to at least one embodiment, the scheduler 154 may mark the task as ready for processing.

According to at least one embodiment, the cloud dispatcher 150 may send the task directly to the at least one worker machine 158.

According to at least one embodiment, the worker machine 158 and/or the cloud dispatcher 150 may task a lookup module 162 to search for certain data on the at least one file server 164.

According to at least one embodiment, the worker machine 158 may verify whether there is at least one scheduled task in the database 165. For example, if one task record is not accessible, the worker machine 158 may discard the corresponding task.

According to at least one embodiment, the worker machine 158 may process the test data. According to at least one embodiment, the worker machine 158 may mark the task as being under processing.

For example, the worker machine 158 may access and copy the test data for each task.

According to at least one embodiment, the worker machine 158 may report the results of data processing to the database 165. For example, the worker machine 158 may generate the test analysis report. For example, the worker machine 158 may mark the task record to identify that the task was completed.

According to at least one embodiment, the ground dispatcher 138 may search for at least one task record corresponding to the completed task. For example, the lookup module 162 may search for at least one task record corresponding to the completed task. For example, once the at least one record of at least one completed task is found, the ground dispatcher 138 may produce at least one diagnostics report (so-called “first report”) for the at least one completed task.

For example, the reporter 168 of the ground dispatcher 138 may send the at least one diagnostics report to interested parties.

According to at least one embodiment, the ground dispatcher 138, or a lookup module 162 may search for the at least one first report at the data center 120. According to at least one embodiment, the ground dispatcher 138, or a lookup module 162 may collect the at least one first report at the data center 120.

According to at least one embodiment, the at least one worker machine 158 may send the result of the analysis to the database 165. For example, the results of the analysis may be a diagnostics report (so-called “first report”). According to at least one embodiment, one or more worker machines 158 may generate an anonymous diagnostics report. This diagnostics report may be data in binary form. For example, the diagnostics report may be completely anonymous, because the patient identification data has not been transmitted to the data center 120.

According to at least one embodiment, the data center 120 may operate in fully automated way and may not need to have any human operator. For example, analysis of the test data may be performed by the worker machines 158 of the data center 120 without any help of personnel. The diagnostics report may also be produced by the at least one worker machine without personnel or any human help.

According to at least one embodiment, the data center 120 may transmit the diagnostics report to the data collection point 130. For example, the worker machine 158 may transmit the diagnostics report to the ground dispatcher 138 via internet or intranet.

According to at least one embodiment, the worker machine 158 may record the diagnostics report at the database 165. For example, the lookup module 162 may search the database 165 to find one or more new diagnostics reports. When one or more diagnostics reports are found, the lookup module 162 may collect the diagnostics report or reports.

According to at least one embodiment, after the ground dispatcher 138 has collected and/or received the diagnostics report, the ground dispatcher 138 may generate an identified report (so-called “second report”), which may comprise the diagnostics report and at least a portion of the patient identification data. For example, the reporter 168 may generate the identified report. The identified report may comprise, for example, the patient's name, address, and other patient's identification information.

The ground dispatcher 138 may then send the identified report to at least one health practitioner. For example, the reporter 168 may then send the identified report to at least one health practitioner. The ground dispatcher 138 may also transmit the identified report to the operator of the data collection point 130.

According to at least one embodiment, the ground dispatcher 138 may transmit the identified report to a communication server 174. For example, the communication center 174 may be operatively connected to the ground dispatcher 138, may be part of the data collection point 130, or may be a separate server, connected with the data collection point 130 via internet or intranet. The communication server 174 may then transmit the identified report to at least one health practitioner.

According to at least one embodiment, the client 172 of the data center 120 may send the information to the supervisor 110. According to at least one embodiment, the client 172 of the data center 120 may communicate with the supervisor 110 to confirm that a patient (customer) and/or data collection point 130 has credits for data processing. According to at least one embodiment, the client 172 of the data center 120 may perform data processing. According to at least one embodiment, the client 172 of the data center 120 may distribute diagnostics reports to participating physicians and/or other interested parties.

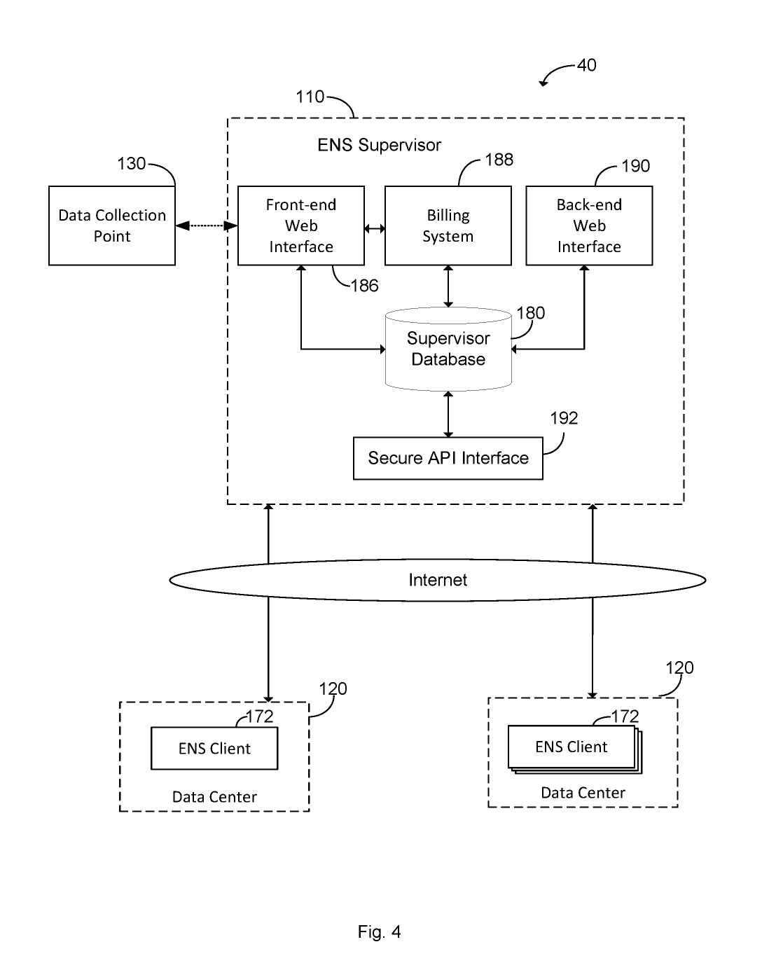

Referring now to FIG. 4, illustrated therein is a portion 40 of the system 10 for remote testing and diagnostics of at least one patient, according to at least one embodiment. The at least one client 172 of the at least one data center 120 may send business information of the data center 120 to the supervisor 110. The supervisor 110 may comprise a supervisor database 180, secure API interface 182, a front-end web interface 186, billing system 188, and a back-end interface 190. The supervisor 110 may further comprise a supervisor e-mail service and a supervisor monitor.

According to at least one embodiment, the data center 120 may send the information to the supervisor 110. For example, the supervisor 110 may permit the data centers 120 to monitor their own activity. The supervisor 110 may connect to the network of data centers 120 in order to monitor only specific criteria, such as, for example, availability of credits, and/or system loading.

According to at least one embodiment, the supervisor may have the front-end web interface 186, which may permit the at least one data collection point 130 to monitor its own activity, tests under way, test performed, and / or statistics that show the loading of the system. The front-end web interface 186 may also be used for further optimization, scaling, and/or buying more credits.

According to at least one embodiment, a service provider may set up one or more data centers 120. For example, the data collection points 130 may be operated independently by one or more business clients, who may provide testing services at cost to the population. For example, the business client may be an institutional operator, e.g., military. For example, the business client may have a service contract with the service provider, according to which the service provider may provide test results in exchange for a fee per test. According to at least one embodiment, the data collection points 130 may be set up by the business client based on specification given by the service provider according to the volume of patients that the business client decides to serve. Each data collection point 130 may have an associated data center 120. For example, the business provider may set up the data collection points 130 according to the number of patients that the business client or business clients desire to test.

According to at least one embodiment, the supervisor 110 may also have a billing system 188. The service provider may be a subscriber to the billing system 188 and may charge the operator of the data collection point 130. For example, the service provider may charge the operator of the data collection point 130 based on a number of tests performed.

According to at least one embodiment, the supervisor 110 may also comprise the back-end interface 190. The back-end interface 190 may permit monitoring of the global system network of data centers 120, reporting the system's activity, and loading statistics to suggest optimization of the system.

According to at least one embodiment, the supervisor 110 may monitor the global activity of the data centers 120 and report in case any of the data collection point 130 has no more credits. For example, the supervisor 110 may be configured to block the operation of the data collection point 130, which does not have any credits left.

According to at least one embodiment, the data collection point 130 may comprise a health practitioners' list. For example, information about at least one health practitioner may be contained in the health practitioner's list. For example, such list may be set-up or generated when the data collection point 130 has been installed. For example, the health practitioners' list may be updated on a regular basis. For example, the health practitioners' list may be updated automatically and/or by an operator.

According to at least one embodiment, the health practitioner may include, for example, a general practitioner, such as, for example, a physician or a physician assistant. The health practitioner may also include health specialists, such as, for example, a cardiologist or a respirologist. The health specialists may also include mental health specialists, for example, psychiatrists, clinical psychologists, etc. For example, the health practitioner may be a somnologist, a sleep specialist, or any other specialist related to field of the test performed by the personal recorder 140. For example, the list of the health practitioners may contain contact information of one or more health practitioner. For example, one health practitioner may be affiliated to one or more data collection points 130.

According to at least one embodiment, the ground dispatcher 138 may analyze the patient identification data. For example, the ground dispatcher 138 may analyze the address of the patient and the health practitioners' list in order to find at least one health practitioner from the health practitioners' list who may practice near the patient's address. For example, the ground dispatcher 138 may choose the health practitioner from the health practitioner's list according to pre-defined criteria.

According to at least one embodiment, the health practitioner, for example, a specialist, may be chosen based on the diagnostics report. For example, the diagnostics report may indicate a “flag” for this purpose. According to at least one embodiment, one “flag”, e.g. cardiac “flag”, in the diagnostics report may indicate that the identified report needs to be sent to a cardiologist, affiliated with the data collection point 130. For example, the diagnostics report may indicate to which health practitioner (or what type of the health practitioner, i.e. cardiologist, respirologist, etc.) the identified report should be sent. For example, the diagnostics report may read “cardiologist”, “physician”, “respirologist”, etc.

According to at least one embodiment, where an impact and/or an outcome of a treatment may be monitored during or after the treatment, the diagnostics report may comprise an indication whether the identified data may need to be sent to the health specialist. For example, when the patient's condition is monitored, the diagnostics report may comprise an indication that the identified report does not need to be sent to the health practitioner. For example, when the patient's condition is monitored, the diagnostics report may comprise an indication that the identified report needs to be sent to the health practitioner as soon as possible.

For example, to monitor patient's condition, the patient may need to subscribe to the monitoring service. For example, the monitoring service may comprise providing the personal recorder 140 to the patient for a determined or undetermined time period, collecting and storing test data of one or more sets of test data and/or diagnostics reports and/or identified reports. For example, the monitoring service may further include analyzing the dynamics of the results of the tests. For example, diagnostics reports of the same monitored patient may be analyzed in order to provide additional information, related to monitoring, to the health specialist in the identified report. For example, comparison with one or more results of previous tests may be performed by analyzing diagnostics reports or identified reports. For example, the monitoring service may comprise comparing of at least two reports of the same patient. For example, two or more diagnostics reports, generated base of the test data collected at two or more different time periods, may be compared and/or the dynamics of the patient's health may be analyzed.

For example, the analysis for the monitoring purposes may be performed at the data center 120 and later sent as a portion of the diagnostics report to the data collection point 130. For example, the analysis for the monitoring purposes may be performed at the data collection point 130.

According to at least one embodiment, the identified reports may be sent to at least one health practitioner affiliated with the data collection point 134. According to at least one embodiment, the ground dispatcher 138 may send the identified report to the health practitioner.

Numerous specific details are set forth herein in order to provide a thorough understanding of the exemplary embodiments described herein. However, it will be understood by those of ordinary skill in the art that these embodiments may be practiced without these specific details. In other instances, well-known methods, procedures and components have not been described in detail so as not to obscure the description of the embodiments. Furthermore, this description is not to be considered as limiting the scope of these embodiments in any way, but rather as merely describing the implementation of these various embodiments.

1. A system for remote health testing and diagnostics of at least one patient, the system comprising:
a) at least one personal recorder, configured to record at least one set of test data during at least one self-applied test;
b) at least one data collection point configured to:
i) receive the at least one set of the test data from the at least one personal recorder, and
ii) receive patient identification data; and
c) a data center configured to:
i) analyze the at least one set of the test data received from the at least one data collection point, and
ii) generate at least one first report based on the analysis of the at least one set of the test data.

2. The system of claim 1, wherein the data collection point is further configured to provide the at least one personal recorder to the at least one patient.

3. The system of claim 1, wherein the personal recorder is configured to test the patient for at least one sleep disorder.

4. The system of claim 1, wherein the personal recorder is configured to test the patient for depression.

5. The system of claim 1, wherein the personal recorder is configured to test respiratory system of the patient.

6. The system of claim 1, wherein the personal recorder is configured to test for at least one cardiovascular disorder.

7. The system of claim 1, wherein the personal recorder is configured to test for at least one neurological disorder.

8. The system of claim 1, wherein the personal recorder is configured to test for pain.

9. The system of claim 1, wherein the personal recorder is configured to test for fatigue.

10. The system of claim 1, wherein the personal recorder is configured to test for at least one neuromuscular disorder.

11. The system of claim 1, wherein the data collection point further comprises:
a ground terminal and
a ground dispatcher, the ground dispatcher configured to:
i) receive the at least one set of test data from the ground terminal, and
ii) transmit the at least one set of test data to the data center.

12. The system of claim 11, wherein the ground terminal is further configured to:
receive at least one set of the patient identification data; and
transmit the at least one set of the patient identification data to the ground dispatcher.

13. The system of claim 12, wherein the ground dispatcher is further configured to
generate a second report, the second report comprising the first report and at least one portion of the at least one set of the patient identification data.

14. The system of claim 13, wherein the ground dispatcher is further configured to send the second report to at least one health practitioner.

15. The system of claim 13, wherein the ground dispatcher is further configured to send the second report to at least one operator of the data collection point.

16. The system of claim 1, wherein the data center further comprises:
at least one worker machine configured to analyze the at least one set of test data; and
a cloud dispatcher configured to transmit the at least one set of the test data, received from the data collection point, to the at least one worker machine.

17. The system of claim 1, wherein the data center is further configured to transmit the at least one first report to the at least one data collection point.

18. The system of claim 11, wherein the ground dispatcher is further configured to:
a) collect the at least one set of test data at the ground terminal and
b) collect the at least one first report at the data center.

19. The system of claim 13, wherein the ground dispatcher further comprises a reporter configured to generate the at least one second report.

20.-24. (canceled)

25. A method for remote (health) testing and diagnostics of at least one patient, the method comprising:
collecting at least one set of test data from at least one personal recorder, the personal recorder being configured to record the at least one set of test data during at least one self-applied test;
transmitting the at least one set of the test data from a data collection point to a data center;
analyzing the at least one set of the test data by the data center; and
generating, by the data center, at least one first report based on the analysis of the at least one set of the test data.

26.-31. (canceled)
